(19) United States
(12) Patent Application Publication
(10) Pub. No.: US 2020/0327806 A1
(43) Pub. Date: Oct. 15, 2020

(54) CONNECTED VEHICLE PLATFORM ASSISTED V2X COMMUNICATIONS

(71) Applicant: T-Mobile USA, Inc., Bellevue, WA (US)

(72) Inventor: Gaviphat Lekutai, Kirkland, WA (US)

(21) Appl. No.: 16/384,422

(22) Filed: Apr. 15, 2019

(51) Int. Cl. G08G 1/09; G08G 1/0967; G08G 1/0965

(52) U.S. Cl. CPC G08G 1/091; G08G 1/096716; G08G 1/0965; G08G 1/096791

(57) ABSTRACT

Techniques are described herein for facilitating V2X communications using a connected vehicle platform. The techniques include receiving, from an onboard diagnostics (OBD) accessory device, vehicle data of a vehicle equipped with the OBD accessory device, the vehicle located at a target location. Thereafter, a traffic advisory message is generated based at least on the vehicle data. Additionally, the techniques include identifying a user equipment located within a predetermined distance of the target location, wherein the user equipment is associated with a user account of a V2X application, the V2X application providing communication settings for the user equipment. The traffic advisory message is then broadcasted to the user equipment based at least on the communication settings of the V2X application.

### BACKGROUND

Vehicle communication systems can comprise vehicle-to-everything (V2X) communication software or programs that can be used to facilitate transmission of information from a vehicle to any entity that may affect the vehicle and vice versa. V2X software generally resides at least partially in a memory unit of a vehicle's computing system and enables the vehicle to act as a communication node when communicating with various entities. For example, vehicles can communicate with other vehicles, infrastructures (e.g., traffic lights), pedestrians with mobile devices, networks, and/or so forth. Thus, V2X can include components such as vehicle-to-vehicle (V2V), vehicle-to-infrastructure (V2I), vehicle-to-pedestrian (V2P), and vehicle-to-network (V2N) communications.

V2X communications can be used for road safety and traffic efficiency purposes. For instance, V2X can be implemented to provide forward collision warning, lane change warning, emergency electric brake light warning, roadworks warning, and/or so forth. In this way, V2X can be applied in autonomous driving. V2X communication can be a wireless local area network (WLAN) based system known as Dedicated Short Range Communications (DSRC) or a cellular-based system. While cellular based V2X can provide a higher percentage of successful data packet delivery and communication range than WLAN based V2X, a vehicle must still be within a communication range of a target entity to enable successful passing of information or data packet delivery in V2X communication. In this regard, V2X communication may be applied only in limited scenarios where vehicles are located in the communication range.

### BRIEF DESCRIPTION OF THE DRAWINGS

The detailed description is described with reference to the accompanying figures, in which the leftmost digit(s) of a reference number identifies the figure in which the reference number first appears. The use of the same reference numbers in different figures indicates similar or identical items.

FIG. 1 illustrates example network architecture for providing connected vehicle platform assisted V2X communications.

FIG. 2 is a block diagram showing various components of an illustrative computing device that implements V2X communications services.

FIG. 3 is a block diagram showing various components of illustrative user equipment (UE) that implements a V2X application.

FIG. 4 is a flow diagram of an example process for broadcasting a traffic advisory message to UE based on feedback from one or more onboard diagnostics (OBD) accessory devices.

FIG. 5 is a flow diagram of an example process for broadcasting a traffic advisory message to a UE.

### DETAILED DESCRIPTION

This disclosure is directed to techniques for facilitating V2X communications using a connected vehicle platform. A general purpose for V2X communications is to enable vehicles to transmit and receive information about their positions, speeds, and directions to prevent vehicular accidents and manage traffic. The vehicles can be equipped with a UE for providing communications services from a network. Communication between two or more UEs in vehicles using V2V communication, a type of V2X communication where two UEs are main agents of the communication, is facilitated using PC5 interface. PC5 interface is used for direct communication between two UEs or between devices supportive of proximity service (ProSE). Generally, PC5 interface is implemented over a short range of less than one km in distance. Thus, broadcasting information via V2V communication using PC5 interface does not provide sufficient time for nearby vehicles to utilize the information to prevent accidents.

In contrast, a communication between a UE and a network using V2N communication, a type of V2X communication where a UE and a serving entity using V2N application are two main agents of the communication and can communicate with each other through an LTE network entity, operates in traditional mobile broadband spectrum using E-UTRAN Uu interface (Uu interface). This means that information can be broadcasted over a greater range of more than one km in distance. However, information may be broadcasted to UEs that are not located near a location of interest, and the UEs may receive an unnecessarily large amount of information.

In one aspect, a UE can comprise an OBD accessory device at least partially residing in a vehicle. The OBD accessory device can include a plug-in component or another communication interface for physically connecting to the vehicle (e.g., via OBD-II, diagnostics port, etc.). The vehicle can include a DSRC system or another short-range, medium-range, or long-range wireless communication system. The OBD accessory device may comprise various hardware and software components configured to scan, read, and/or collect vehicle data from the vehicle's OBD device. For example, the vehicle data can include speed data, vehicle disturbance data, movement data, braking data, vehicle warning system codes (e.g., low battery), and/or so forth. Additionally, the OBD accessory device can comprise a Global Positioning System (GPS) component for collecting location data or GPS data.

The OBD accessory device also includes a communication device for transmitting vehicle reports comprising vehicle data to a network entity. In one aspect, the OBD accessory device sends the vehicle report to a base station (e.g., eNode B), and then the base station broadcasts specific Intelligent Transport System (ITS) messages based at least on the vehicle report. ITS messages can comprise intersection collision warning, emergency brake warning, left turn assist, traffic jam warning, vulnerable road user warning, and/or so forth. Additionally, ITS messages can include a map highlighting congested areas, high traffic areas, road closures and repairs, construction zones, and other target areas that affect traffic. The messages are broadcasted to selected UEs comprising mobile devices subscribed to communications services provided by a telecommunications service provider.

In some aspects, the OBD accessory device can be a component of a connected vehicle platform. In this regard, a UE (i.e., a mobile device) can include an application installed thereon for supporting communication between the UE and the OBD accessory device and/or the base station. More specifically, the application enables the UE to select opt-in settings to receive vehicle reports and/or ITS messages from the OBD accessory device and/or the base station. Once opted-in to receive messages or other communications at the UE, a subscriber can use the messages or mapping information to help avoid traffic congestion and accidents while optimizing travel time.

The techniques described herein may be implemented in a number of ways. Example implementations are provided below with reference to the following figures.

### Example Network Architecture

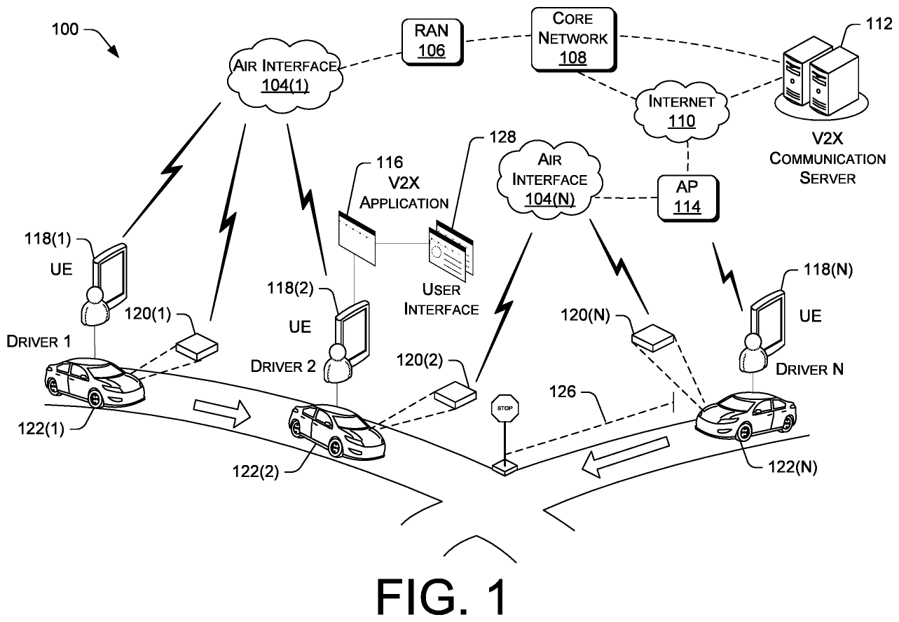

FIG. 1 illustrates example architecture for providing connected vehicle platform assisted V2X communications. The architecture may include one or more UEs 118(1)-118(N) in a wireless communication network 100. The one or more UEs 118(1)-118(N) can include smartphones, mobile devices, personal digital assistants (PDAs) or other electronic devices having a wireless communication function that is capable of receiving input, processing the input, and generating output data. In various embodiments, the UEs 118(1)-118(N) can be installed in vehicles 122(1)-122(N). The UEs 118(1)-118(N) can communicate with an access network (e.g., a radio access network (RAN) 106, an access point (AP) 114, etc.) over a physical communications interface or network access technologies. For example, the air interfaces 104(1)-104(N) may serve the UEs 118(1)-118(N) over a local wireless connection. The air interfaces 104(1)-104(N) can comply with a given cellular communications protocol. For example, the network can implement 2G, 3G, 4G, 5G, long-term evolution (LTE), LTE advanced, high-speed data packet access (HSDPA), evolved high-speed packet access (HSPA+), universal mobile telecommunication system (UMTS), code-division multiple access (CDMA), global system for mobile communications (GSM), a local area network (LAN), a wide area network (WAN), and/or a collection of networks (e.g., the Internet).

The RAN 106 can include a plurality of APs that serve the UEs 118(1)-118(N) over air interfaces 104(1)-104(N). An AP in the RAN 106 can be referred to as an access node (AN), a base station, Node B, evolved Node B (eNode B), and/or so forth. An AP can be a terrestrial access point or a satellite access point. The RAN 106 connects to a core network 108 that can perform a variety of functions, including bridging circuit switched calls between UEs served by the RAN 106 and other UEs served by the RAN 106 or a different RAN. The RAN 106 can also mediate an exchange of packet-switched (PS) data with external networks such as the Internet 110. The Internet 110 can include a number of routing agents and processing agents (not shown). In various embodiments, the Internet 110 can function to bridge packet-switched data communication between a first UE 118(1) and a second UE 118(2) via the core network 108.

In the illustrated embodiment, the AP 114 may be separate from the RAN 106. The AP 114 can be connected to the Internet 110 independent of the core network 108. The core network 108 can provide one or more communications services (e.g., voice-over-Internet Protocol (VoW) sessions, push-to-talk (PTT) sessions, group communication sessions, etc.) for UEs 118(1)-118(N) that connect to the core network 108 via the RAN 106 and/or the Internet 110 and/or to provide content to the UEs 118(1)-118(N).

The network 100 as illustrated in FIG. 1 includes a plurality of network nodes, including a base station (i.e., AP 114). Various operations performed for communication with the UEs 118(1)-118(N) and OBD accessory devices 120(1)-120(N) may be performed by the base station or network nodes other than the base station. For example, the V2X communication server 112 may perform one or more operations for supporting communication between the UEs 118(1)-118(N) and OBD accessory devices 120(1)-120(N).

The V2X communication server 112 may include general-purpose computers, such as desktop computers, tablet computers, laptop computers, servers (e.g., on-premise servers), or other electronic devices that are capable of receiving input, processing the input, and generating output data. The V2X communication server 112 may store data in a distributed storage system. Further, the V2X communication server 112 can be implemented as a plurality of separate servers that may be grouped together and presented as a single computing system. Each physical machine of the plurality of physical machines may comprise a node in a cluster. The V2X communication server 112 may also be in the form of virtual machines, such as virtual engines (VE) and virtual private servers (VPS). The V2X communication server 112 can be operated by a telecommunications service provider and/or a third party working with the telecommunications service provider. As will be described below, the V2X communication server 112 may provide V2X communications service for collecting vehicle reports from one or more OBD accessory devices 120(1)-120(N) and broadcasting traffic advisory messages to one or more UEs 118(1)-118(N).

The UEs 118(1)-118(N) illustrated in FIG. 1 may include a locally installed V2X application 116. In various embodiments, the V2X application 116 can be web-based. The V2X application 116 may support communications from the V2X communication server 112 and monitor vehicles that each have an OBD accessory device 120(1)-120(N) installed thereon. Additionally, the V2X application 116 may enable users to create or sign into a user account, add or remove vehicles, view or edit vehicle information, view and share trip history, define geofences, view and share driving reports, customize mobile hotspot settings, customize communication settings, request roadside assistance, receive traffic advisory messages, and/or so forth. Further, the V2X application 116 may enable the UEs 118(1)-118(N) to facilitate V2X communications with the air interfaces 104(1)-104(N) or other network entities.

The OBD accessory devices 120(1)-120(N) may include an interface for connecting to a vehicle's OBD connector port (e.g., OBD-II) in order to communicate with the vehicle's OBD device. Upon connecting to a vehicle, the OBD accessory devices 120(1)-120(N) can search for the network 100 in order to establish a connection. In this regard, the OBD accessory devices 120(1)-120(N) may include a communication device for transmitting vehicle data over one or more of the air interfaces 104(1)-104(N) via the Uu interface or other radio interfaces. For example, the OBD accessory devices 120(1)-120(N) may be configured to transmit vehicle data to the V2X communication server 112 via LTE by way of the first air interface 104(1). In another example, the OBD accessory devices 120(1)-120(N) may be configured to transmit vehicle data to the V2X communication server via Wi-Fi by way of the second air interface 104(N). The OBD accessory devices 120(1)-120(N) can exchange information such as the vehicle's position, speeds, directions, and/or other vehicle data. However, before communicating over the one or more of the air interfaces 104(1)-104(N), the OBD accessory devices 120(1)-120(N) must first be activated with the V2X communication server 112.

The V2X application 116 can include an onboarding feature for activating the OBD accessory devices 120(1)-120(N). In various embodiments, the first UE 118(1) can register the first OBD accessory device 120(1) with the V2X communication server 112 upon receiving an International Mobile Equipment Identity (IMEI) number of the OBD accessory device 120(1) by uploading the IMEI number to the V2X communication server 112. The OBD accessory device 120(1) can also comprise a subscriber identification module (SIM) card. Thus, an integrated circuit card identifier (ICCID) can also be uploaded to the V2X communication server 112 during the onboarding process. In other aspects, the first OBD accessory device 120(1) can comprise one or more visual matrix codes, such as QR codes, Aztec Codes, or Maxi Codes printed thereon, which the first UE 118(1) can scan to obtain a unique identifier correlating to the OBD accessory device 120(1) and upload the identifier to register the OBD accessory device 120(1) with the V2X communication server 112.

In addition to uploading the unique identifier of the OBD accessory device 120(1), the UE 118(1) can also upload a subscriber indicia of the subscriber (e.g., the driver of the vehicle 122(1)) associated with the UE 118(1). The subscriber indicia can include the subscriber account identifier, IMEI number of the UE 118(1), or other indicia such as ICCID of the SIM card of the UE 118(1) to enable the telecommunications service provider of the network 100 to identify the subscriber as a current, active subscriber. The subscriber indicia and the OBD accessory device identifier can be associated with a subscriber account of a telecommunications service for billing or other related services.

In this way, once the UE 118(1) registers the OBD accessory device 120(1) with the V2X communication server 112, the OBD accessory device 120(1) can communicate with the network 100. Upon connecting to the network 100, the OBD accessory device 120(1) can send the make and model and the vehicle identification number (VIN) of the vehicle in which it is installed (i.e., the first vehicle 122(1) as illustrated in FIG. 1) to the UE 118(1) to associate the identity of the vehicle 122(1) with the OBD accessory device 120(1) and the user account of the V2X application 116. The onboarding process is repeated each time a new OBD accessory device is installed in a vehicle, an existing OBD accessory device is installed in a different vehicle, and/or so forth.

Each user account for the V2X application 116 can manage multiple vehicles by registering a plurality of OBD accessory devices 120(1)-120(N). Thus, a user account can be associated with a particular OBD accessory device identifier (e.g., IMEI number). The individual OBD accessory devices 120(1)-120(N) can reside at least partially in a vehicle. Accordingly, the first OBD accessory device 120(1) is installed in the first vehicle 122(1), the second OBD accessory device 120(2) is installed in the second vehicle 122(2), and so on, as illustrated in FIG. 1. In one example, one user account can manage both the first vehicle and the second vehicle having the first OBD accessory device 120(1) and the second OBD accessory device 120(2) installed thereon, respectively. In another example, a first user account can manage the first vehicle having the first OBD accessory device 120(1) installed thereon, and a second user account can manage the second vehicle having the second OBD accessory device 120(2) installed thereon.

The OBD accessory devices 120(1)-120(N) are configured to collect vehicle information, such as the vehicle's VIN, odometer, vehicle status, trip information, driving reports, and/or so forth. The trip information can include a map of individual trips, rapid accelerations, harsh brakes, idling, distance traveled, duration of a trip, maximum vehicle speed, average vehicle speed, maximum revolutions per minute (RPM), fuel efficiency, and/or so forth. If multiple vehicles are registered under a user account, the application user interface 128 can display a list of vehicles. A user can tap on the vehicle's name from the list to select the desired vehicle and view the vehicle's trip information and other related vehicle data.

The vehicle data collected at the OBD accessory devices 120(1)-120(N) can be used to generate a vehicle report, which can then be transmitted to the V2X communication server 112. Based at least on the vehicle report, the V2X communication server 112 can generate a traffic advisory message. In various embodiments, the traffic advisory message can comprise an ITS message. More specifically, if the vehicle report indicates that there are unsafe road conditions such as high-speed driving or weather-related conditions, the V2X communication server 112 can generate a traffic advisory message comprising a warning to enable subscribers to drive with caution and reduce accidents.

The traffic advisory message can be broadcasted to a selected group of one or more UEs 118(1)-118(N) that has opted-in to receive notifications via the V2X application 116. In this regard, the V2X communication server 112 can filter a list of one or more UEs 118(1)-118(N) that opted-in to receive notifications. In various embodiments, the V2X communication server 112 can broadcast the traffic advisory message to a selected group of the one or more UEs 118(1)-118(N) based on their respective locations. For example, the V2X communication server 112 can broadcast a traffic advisory message to all UEs located within a predetermined distance of a target location. Upon receiving the message, the V2X application 116 can then determine whether the UE has selected opt-in to receive notifications in communication settings. If the UE has opted-in to receive notifications, the V2X application 116 displays the traffic advisory message.

Additionally, the traffic advisory message is broadcasted to UEs 118(1)-118(N) moving in vehicles. For example, the UEs 118(1)-118(N) can receive traffic advisory messages from the V2X communication server 112 when the UEs 118(1)-118(N) are in a vehicle-mode or driving-mode. The UEs 118(1)-118(N) can be in a vehicle-mode or driving-mode when connected to a vehicle via Bluetooth. Additionally, or alternatively, the UEs 118(1)-118(N) can receive traffic advisory messages from the V2X communication server 112 when the UEs 118(1)-118(N) are moving at a speed above a predetermined threshold. In some aspects, the position and speed of the UEs 118(1)-118(N) can be approximated using techniques that implement the Doppler effect, which includes measuring the variation and frequency of signals (e.g., Wi-Fi signals) received at the UEs 118(1)-118(N) from nearby access points (e.g., Wi-Fi router).

In one example, the vehicle report from the OBD accessory device 120(2) of the second vehicle 122(2) can indicate that the second vehicle 122(2) is malfunctioning and stopped at an intersection. Upon receiving the vehicle report from the OBD accessory device 120(2) of the second vehicle 122(2), the V2X communication server 112 can generate a traffic advisory message indicating the presence of an inoperative vehicle (i.e., the second vehicle 122(2)) at a target location (i.e., the second vehicle's location). Thereafter, the V2X communication server 112 can identify UEs 118(1)-118(N) in moving vehicles that are located within a predetermined distance of the second vehicle 122(2) or the target location, and the UEs 118(1)-118(N) that opted-in to receive notifications via the V2X application 116. In the illustrated embodiment, the UE 118(N) is inside the vehicle 122(N) that is located within the predetermined distance 126 of the second vehicle 122(2) or the target location. In various embodiments, additional UEs may be located within the predetermined distance of the target location. If the UE 118(N) opted-in to receive notifications, the V2X communication server 112 sends the traffic advisory message to the UE 118(N). Upon receiving the traffic advisory message at the UE 118(N), the driver of the vehicle 122(N) can make one or more traffic decisions. For example, the driver may decide to choose an alternate route for traveling.

### Example Computing Device Components

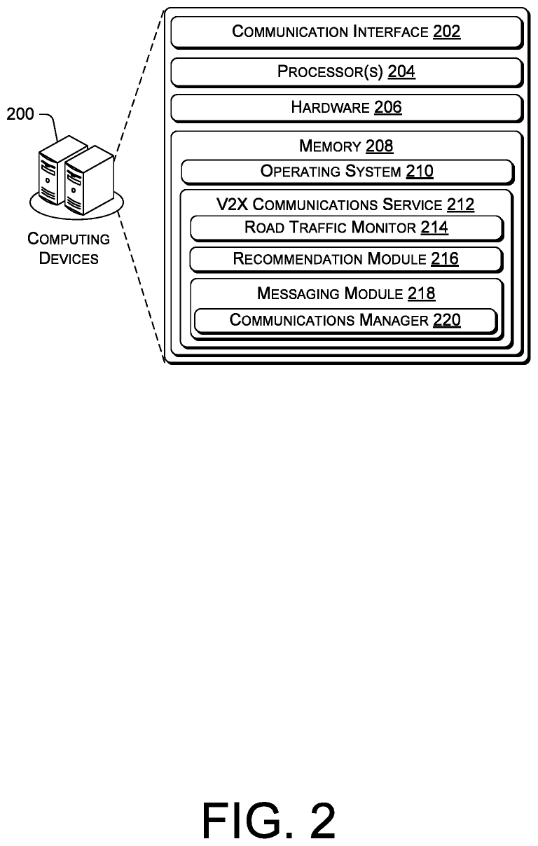

FIG. 2 is a block diagram showing various components of illustrative computing devices 200, wherein the computing devices 200 can comprise a V2X communication server. It is noted that the computing devices 200 as described herein can operate with more or fewer of the components shown herein. Additionally, the computing devices 200 shown herein or portions thereof can serve as a representation of one or more of the computing devices 200 of the present system.

The computing devices 200 may include a communication interface 202, one or more processors 204, hardware 206, and memory 208. The communication interface 202 may include wireless and/or wired communication components that enable the computing devices 200 to transmit data to and receive data from other networked devices. In at least one example, the one or more processor(s) 204 may be a central processing unit(s) (CPU), graphics processing unit(s) (GPU), both a CPU and GPU or any other sort of processing unit(s). Each of the one or more processor(s) 204 may have numerous arithmetic logic units (ALUs) that perform arithmetic and logical operations as well as one or more control units (CUs) that extract instructions and stored content from processor cache memory, and then executes these instructions by calling on the ALUs, as necessary during program execution.

The one or more processor(s) 204 may also be responsible for executing all computer applications stored in the memory, which can be associated with common types of volatile (RAM) and/or nonvolatile (ROM) memory. The hardware 206 may include additional user interface, data communication, or data storage hardware. For example, the user interfaces may include a data output device (e.g., visual display, audio speakers), and one or more data input devices. The data input devices may include but are not limited to, combinations of one or more of keypads, keyboards, mouse devices, touch screens that accept gestures, microphones, voice or speech recognition devices, and any other suitable devices.

The memory 208 may be implemented using computer-readable media, such as computer storage media. Computer-readable media includes, at least, two types of computer-readable media, namely computer storage media and communications media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms. The memory 208 may also include a firewall. In some embodiments, the firewall may be implemented as hardware 206 in the computing devices 200.

The processors 204 and the memory 208 of the computing devices 200 may implement an operating system 210 and a V2X communications service 212. In various embodiments, the computing devices 200 may also include a data management layer (not shown) that includes software utilities for facilitating the acquisition, processing, storing, reporting, and analysis of data from data sources such as OBD accessory devices, UEs, and/or so forth. In various embodiments, the data management layer can interface with an Application Programming Interface (API) for providing data access.

The operating system 210 may include components that enable the computing devices 200 to receive and transmit data via various interfaces (e.g., user controls, communication interface, and/or memory input/output devices), as well as process data using the processors 204 to generate output. The operating system 210 may include a presentation component that presents the output (e.g., display the data on an electronic display, store the data in memory, transmit the data to another electronic device, etc.). Additionally, the operating system 210 may include other components that perform various additional functions generally associated with an operating system.

The V2X communications service 212 includes a road traffic monitor 214, a recommendation module 216, and a messaging module 218 comprising a communications manager 220. The road traffic monitor 214, the recommendation module 216, the messaging module 218, and the communication manager 220 can include routines, program instructions, objects, and/or data structures that perform particular tasks or implement particular abstract data types.

For instance, the road traffic monitor 214 may include one or more instructions, when executed by the one or more processors 204 to direct the computing devices 200 to perform operations related to receiving real-time traffic information or traffic reports from one or more traffic information systems, processing, and presenting the real-time traffic information to a UE. The traffic information can include traffic delays and road closures and conditions, including weather information. Additionally, the traffic information can include average travel time between two or more locations, average vehicle speed on various roads and highways, bicyclists and pedestrian traffic information, travel alerts, and/or so forth. Based at least on the traffic information or traffic reports received from one or more traffic information systems, the road traffic monitor 214 may automatically detect an anomaly in traffic patterns, depending upon embodiments.

In some aspects, the road traffic monitor 214 can receive traffic information and/or vehicle reports from one or more OBD accessory devices, wherein the individual OBD accessory devices are associated with a respective vehicle. Thus, the vehicle reports are associated with a particular vehicle and the vehicle's VIN. The vehicle reports can include various vehicle-related data, such as the vehicle's location, timestamp, distance traveled, duration of a trip, diagnostic trouble codes (e.g., low battery, powertrain/vehicle speed control fault P1572 codes), disturbance to the vehicle, and/or so forth. The road traffic monitor 214 may identify one or more conditions from the vehicle reports that may affect traffic. For example, if a vehicle report indicates that an OBD accessory device detected harsh braking, a collision, and a deployed airbag, the road traffic monitor 214 can determine that the vehicle associated with the OBD accessory device was involved in an accident, which can increase traffic and cause delays on the road on which the vehicle is located.

The road traffic monitor 214 may reference a database for identifying conditions that can cause traffic delays. Additionally, the road traffic monitor 214 may request updated real-time traffic information or traffic reports from one or more traffic information systems upon identifying one or more conditions that can cause traffic delays. For instance, if the road traffic monitor 214 determines that an accident occurred in the above example, the road traffic monitor 214 may request updated traffic information to obtain the most up-to-date average travel time between two or more locations, average vehicle speed on various roads and highways, travel alerts, and/or so forth.

The road traffic monitor 214 may provide the traffic information and/or the vehicle reports to the recommendation module 216. The recommendation module 216 is configured to generate a traffic advisory message based at least on the traffic information and/or the vehicle reports. In this regard, the recommendation module 216 may implement one or more data filtering tools that use predefined rules and algorithms to generate a traffic advisory message. For example, if the road traffic monitor 214 determines that one or more conditions from the vehicle reports indicate an increase in traffic or traffic delays, the recommendation module 216 may generate a message recommending a driver take an alternate route. In another example, if the road traffic monitor 214 identifies unsafe road conditions due to inclement weather, the recommendation module 216 may generate a message recommending a driver reduce speed or drive with caution. In yet another example, if the road traffic monitor 214 identifies road obstacle or construction, the recommendation module 216 may generate a message warning a driver of nearby road repairs.

The recommendation module 216 may provide the generated messages to the messaging module 218. The messaging module 218 provides operations related to communicating with UEs in the network. For example, in one aspect, upon receiving a traffic advisory message, the messaging module 218 may transmit the traffic advisory message to one or more UEs, wherein the UEs are associated with subscribers of a telecommunications service. The messaging module 218 may implement the communication manager 220 for managing the exchange of information between the V2X communication server and the UEs. For instance, the communication manager 220 may identify a subscriber account associated with a UE using a subscriber indicia associated with the UE (e.g., ICCID). Based on the subscriber indicia, the communication manager 220 retrieves, from a user account database, communication settings of a user account of a V2X application associated with the subscriber indicia. If the communication settings indicate that the UE selected opt-in to receive communications from the V2X communication server, the communication manager 220 may enable the messaging module 218 to send the traffic advisory message to the UE. In various embodiments, the communication manager 220 may enable the messaging module 218 to transmit emergency messages to all UEs, including UEs that has opted-out of receiving communications from the V2X communication server.

Further, the communication manager 220 identifies UEs that are located in a moving vehicle driving within a predetermined distance of a target location, whereby the target location can be a location of another vehicle, such as an inoperable vehicle on a road. In one instance, the communication manager 220 can query the status of a UE to determine whether the UE is in a vehicle-mode or driving-mode. In this way, UEs can receive communications from the V2X communication server based on its status, location, and communication settings of the V2X application.

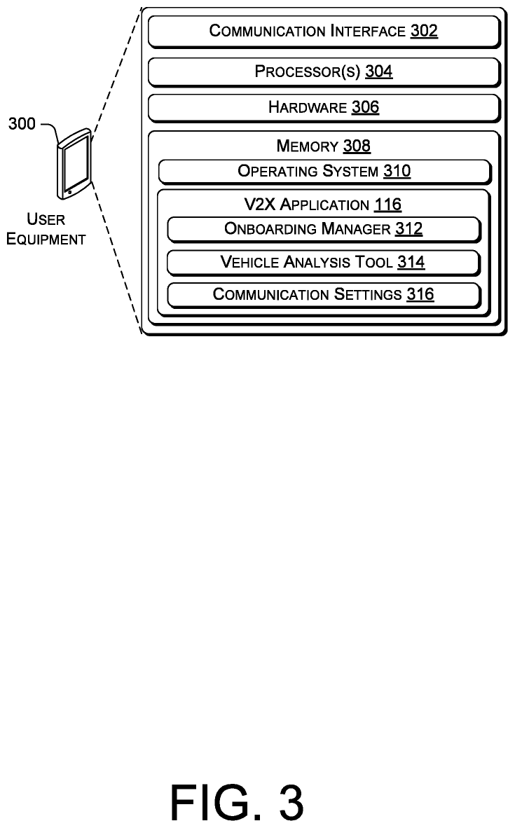

FIG. 3 is a block diagram showing various components of an illustrative UE that implements a V2X application. It is noted that the UE 300 as described herein can operate with more or fewer of the components shown herein. Additionally, the UE 300 shown herein or portions thereof can serve as a representation of one or more of the UE 300 of the present system.

The UE 300 may include a communication interface 302, one or more processors 304, hardware 306, and memory 308. The communication interface 302 may include wireless and/or wired communication components that enable the UE 300 to transmit data to and receive data from other networked devices. In at least one example, the one or more processor(s) 304 may be a central processing unit(s) (CPU), graphics processing unit(s) (GPU), both a CPU and GPU or any other sort of processing unit(s). Each of the one or more processor(s) 304 may have numerous arithmetic logic units (ALUs) that perform arithmetic and logical operations as well as one or more control units (CUs) that extract instructions and stored content from processor cache memory, and then executes these instructions by calling on the ALUs, as necessary during program execution.

The one or more processor(s) 304 may also be responsible for executing all computer applications stored in the memory, which can be associated with common types of volatile (RAM) and/or nonvolatile (ROM) memory. The hardware 306 may include additional user interface, data communication, or data storage hardware. For example, the user interfaces may include a data output device (e.g., visual display, audio speakers), and one or more data input devices. The data input devices may include but are not limited to, combinations of one or more of keypads, keyboards, mouse devices, touch screens that accept gestures, microphones, voice or speech recognition devices, and any other suitable devices.

The memory 308 may be implemented using computer-readable media, such as computer storage media. Computer-readable media includes, at least, two types of computer-readable media, namely computer storage media and communications media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms. The memory 308 may also include a firewall. In some embodiments, the firewall may be implemented as hardware 306 in the UE 300.

The processors 304 and the memory 308 of the UE 300 may implement an operating system 310 and a V2X application 116. In various embodiments, the UE 300 may also include a data management layer (not shown) that includes software utilities for facilitating the acquisition, processing, storing, reporting, and analysis of data from data sources such as OBD accessory devices, V2X communication server, and/or so forth. In various embodiments, the data management layer can interface with an API for providing data access.

The operating system 310 may include components that enable the UE 300 to receive and transmit data via various interfaces (e.g., user controls, a communication interface, and/or memory input/output devices), as well as process data using the processors 304 to generate output. The operating system 310 may include a presentation component that presents the output (e.g., display the data on an electronic display, store the data in memory, transmit the data to another electronic device, etc.). Additionally, the operating system 310 may include other components that perform various additional functions generally associated with an operating system.

The V2X application 116 facilitates communications from the V2X communication server and monitor vehicles that are equipped with OBD accessory devices. The V2X application 116 may include an onboarding manager 312, vehicle analysis tool 314, and communication settings 316. The onboarding manager 312 is configured to perform one or more operations related to activating an OBD accessory device to communicate with a network. For example, upon installing the OBD accessory device in a vehicle, the UE may receive a unique OBD accessory device identifier (e.g., IMEI number, ICCID) of the OBD accessory device. The onboarding manager 312 can then present a user interface to allow the user to add or remove a vehicle under a user account of the V2X application 116, view or edit vehicle information, view and share trip history, define geofences for the vehicle (e.g., name, address, and/or six-point or circular boundary), and/or so forth.

Once the vehicle is added, the onboarding manager 312 may upload the OBD accessory device identifier of the OBD accessory device to the V2X communication server, where the V2X communication server enables the OBD accessory device to communicate via the network. In addition to uploading the OBD accessory device identifier, the UE may also upload to the V2X communication server a subscriber indicia of the user associated with the UE. The subscriber indicia can include a subscriber account number, an IMEI number of the UE, ICCID of the UE, and/or other identifiers for identifying the user as a subscriber of an active subscriber account.

The vehicle analysis tool 314 is configured to perform operations related to receiving, processing, and displaying vehicle data related to one or more vehicles registered under a user account. For example, upon adding the vehicle, the vehicle analysis tool 314 receives, from the OBD accessory device in the vehicle, vehicle data associated with the vehicle. The vehicle analysis tool 314 may then provide a user interface to allow the user to view driving reports for the vehicle, customize the vehicle's mobile hotspot settings, and/or so forth. The driving reports can be shared with other users associated with the user account.

The V2X application 116 further includes a user interface for enabling a user to customize communication settings 316. For example, a user can choose opt-in to receive communications (e.g., traffic advisory messages) from the V2X communication server. In some aspects, the user can turn notifications, banners, and sounds on or off. The V2X application 116 may also provide an interface to allow the user to designate emergency contacts from the user's address book residing in the UE to notify when requesting roadside assistance.

### Example Processes

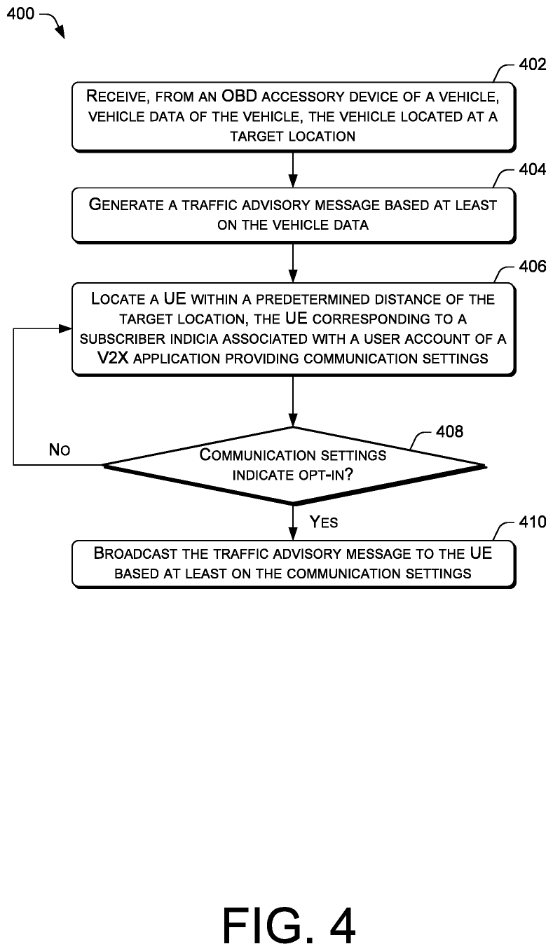

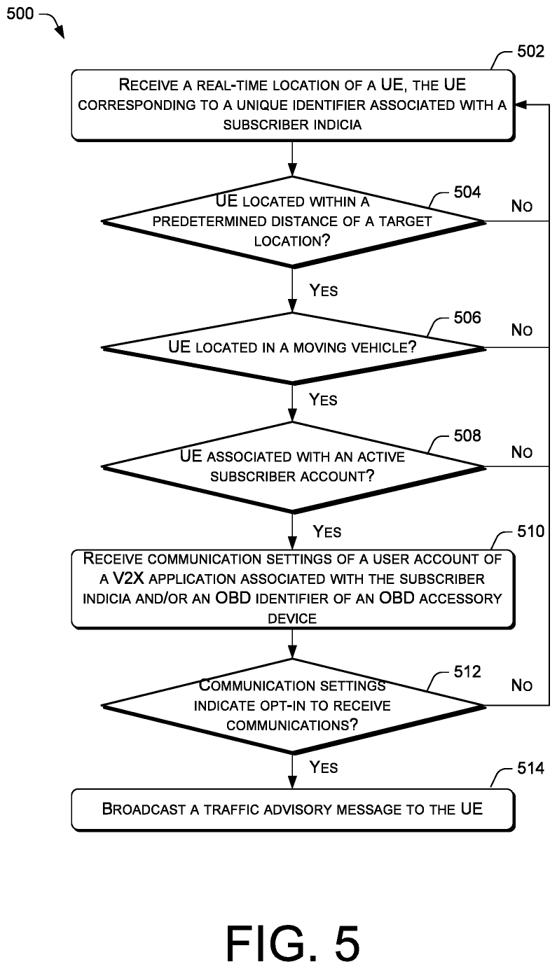

FIGS. 4-5 present illustrative processes 400-500 for facilitating V2X communication. The processes 400-500 are illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 400-500 are described with reference to the network 100 of FIG. 1.

FIG. 4 is a flow diagram of an example process 400 for propagating a traffic advisory message to one or more UEs based on feedback from one or more OBD accessory devices, from the perspective of a V2X communication server. At block 402, the road traffic monitor of the V2X communication server receives, from an OBD accessory device of a vehicle, vehicle data of the vehicle, wherein the vehicle is located at a target location. The OBD accessory device can be associated with a unique identifier such as IMEI number, ICCID, and/or other unique identifiers of the OBD accessory device.

At block 404, the recommendation module of the V2X communication server generates a traffic advisory message based at least on the vehicle data. The traffic advisory message can include appropriate warning messages to help drivers avoid traffic accidents and provide better route planning. For example, if the vehicle report indicates one or more conditions that trigger traffic delays or unsafe road conditions, the recommendation module may generate a message recommending a driver take an alternate route and/or drive with caution. Conditions that trigger traffic delays or unsafe road conditions include stalled cars, road repairs or construction, overturned vehicles, weather-related conditions, road closures, vehicle accidents, and/or so forth. At block 406, the communications manager of the V2X communication server locates a UE within a predetermined distance of the target location (i.e., the location of the vehicle), wherein the UE corresponds to a subscriber indicia associated with a user account of a V2X application. The subscriber indicia can include ICCID, IMEI number, a subscriber account number, and/or so forth.

At decision block 408, the communications manager of the V2X communication server determines whether the UE opted-in to receive communications from the V2X communication server, via the V2X application. If the UE opted-in to receive communications from the V2X communication server, the messaging module of the V2X communication server broadcasts the traffic advisory message generated via the recommendation module of the V2X communication server to the UE, as indicated in block 410.

FIG. 5 is a flow diagram of an example process 500 for broadcasting a traffic advisory message to a UE. At block 502, the communications manager of the V2X communication server receives a real-time location of a UE. The UE corresponds to a unique identifier such as the ICCID, IMEI number, and/or so forth. The identifier (e.g., ICCID, IMEI number) of the device is associated with a subscriber indicia such as a subscriber account number of a telecommunications service.

At decision block 504, the communication manager of the V2X communication server determines whether the UE is located within a predetermined distance of a target location. The target location can be the location of a vehicle accident, a construction zone, a stalled vehicle, and/or another location where a user should drive with caution. If the UE is located within the predetermined distance (“yes” response from the decision block 504), the communication manager determines whether the UE is located in a moving vehicle, as indicated in decision block 506. For example, if the UE is in a vehicle-mode or driving-mode, the communication manager determines that the UE is in a moving vehicle. If the UE is not located within the predetermined distance of the target location (“no” response from the decision block 504), the communication manager continuously receives location information of the UE until the UE is within the predetermined distance of the target location. Additionally, or alternatively, the communication manager receives location information from other UEs to determine whether other UEs are located within the predetermined distance.

If the UE is in a moving vehicle (“yes” response from the decision block 506), the communications manager of the V2X communication server determines, based on the subscriber indicia, whether the UE is associated with an active subscriber account, as indicated in decision block 508. If the UE is not located within the predetermined distance of the target location (“no” response from the decision block 506), the process may restart at block 502. If the UE is associated with an active subscriber account (“yes” response from the decision block 508), the communications manager retrieves communication settings of a user account of a V2X application associated with the subscriber indicia, as indicated in block 510. In various embodiments, an OBD accessory device identifier of a registered OBD accessory device may be used to identify the user account, wherein the OBD accessory device identifier may be associated with the user account. Communication settings can be stored in a user account database that is in communication with the V2X communication server. If the UE is not located within the predetermined distance of the target location (“no” response from the decision block 508), the process may restart at block 502. At decision block 512, the communications manager determines whether the communication settings for the user account indicates that a subscriber has opted-in to receive communications from the V2X server. If the subscriber has opted-in to receive communications, (“yes” response from the decision block 512), the messaging module of the V2X communication server serves the traffic advisory message to the UE, as indicated in block 514. If the UE is not located within the predetermined distance of the target location (“no” response from the decision block 512), the process may restart at block 502.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. One or more non-transitory computer-readable media storing computer-executable instructions that upon execution cause one or more processors to perform acts comprising:
receiving, from an onboard diagnostics (OBD) accessory device associated with a first user account, vehicle data of a vehicle equipped with the OBD accessory device, the vehicle located at a target location;
generating a traffic advisory message based at least on the vehicle data;
identifying a user equipment located within a predetermined distance of the target location, the user equipment associated with a second user account of a V2X application, the V2X application providing communication settings for the user equipment; and
broadcasting the traffic advisory message to the user equipment based at least on the communication settings of the V2X application.

2. The one or more non-transitory computer-readable media of claim 1, wherein the user equipment is located in an additional vehicle driving within the predetermined distance of the target location, the additional vehicle equipped with an additional OBD accessory device associated with the second user account.

3. The one or more non-transitory computer-readable media of claim 1, wherein the OBD accessory device corresponds to a unique OBD accessory device identifier comprising an International Mobile Equipment Identity (IMEI) number of the OBD accessory device.

4. The one or more non-transitory computer-readable media of claim 1, wherein the vehicle data comprises speed data, vehicle disturbance data, movement data, braking data, vehicle warning system codes, and location data associated with the vehicle.

5. The one or more non-transitory computer-readable media of claim 1, wherein the traffic advisory message includes an intelligent transportation system (ITS) message.

6. The one or more non-transitory computer-readable media of claim 1, wherein the acts further comprise:
sending the vehicle data of the vehicle to an additional user equipment, the additional user equipment associated with an additional user account of the V2X application.

7. The one or more non-transitory computer-readable media of claim 1, wherein the one or more non-transitory computer-readable media comprises an on-premise server.

8. A computer-implemented method, comprising:
receiving, from an onboard diagnostics (OBD) accessory device associated with a first user account, vehicle data of a vehicle equipped with the OBD accessory device, the vehicle located at a target location;
generating a traffic advisory message based at least on the vehicle data;
identifying a user equipment located within a predetermined distance of the target location, the user equipment associated with a user second account of a V2X application, the V2X application providing communication settings for the user equipment; and
broadcasting the traffic advisory message to the user equipment based at least on the communication settings of the V2X application.

9. The computer-implemented method of claim 8, wherein the user equipment is located in an additional vehicle driving within the predetermined distance of the target location, the additional vehicle equipped with an additional OBD accessory device associated with the second user account.

10. The computer-implemented method of claim 8, wherein the OBD accessory device corresponds to a unique OBD accessory device identifier comprising International Mobile Equipment Identity (IMEI) number of the OBD accessory device.

11. The computer-implemented method of claim 8, wherein the vehicle data comprises speed data, vehicle disturbance data, movement data, braking data, vehicle warning system codes, and location data associated with the vehicle.

12. The computer-implemented method of claim 8, wherein the traffic advisory message includes an intelligent transportation system (ITS) message.

13. The computer-implemented method of claim 8, further comprising:
sending the vehicle data of the vehicle to an additional user equipment, the additional user equipment associated with an additional user account of the V2X application.

14. A system, comprising:
one or more non-transitory storage mediums configured to provide stored computer-readable instructions, the one or more non-transitory storage mediums coupled to one or more processors, the one or more processors configured to execute the computer-readable instructions to cause the one or more processors to:
receive, from an onboard diagnostics (OBD) accessory device associated with a first user account, vehicle data of a vehicle equipped with the OBD accessory device, the vehicle located at a target location;
generate a traffic advisory message based at least on the vehicle data;
identify a user equipment located within a predetermined distance of the target location, the user equipment associated with a second user account of a V2X application, the V2X application providing communication settings for the user equipment; and
broadcast the traffic advisory message to the user equipment based at least on the communication settings of the V2X application.

15. The system of claim 14, wherein the user equipment is located in an additional vehicle driving within the predetermined distance of the target location, the additional vehicle equipped with an additional OBD accessory device associated with the user second account.

16. The system of claim 14, wherein the OBD accessory device corresponds to a unique OBD accessory device identifier comprising an International Mobile Equipment Identity (IMEI) number of the OBD accessory device.

17. The system of claim 14, wherein the vehicle data comprises speed data, vehicle disturbance data, movement data, braking data, vehicle warning system codes, and location data associated with the vehicle.

18. The system of claim 14, wherein the traffic advisory message includes an intelligent transportation system (ITS) message.

19. The system of claim 14, sending the vehicle data of the vehicle to an additional user equipment, the additional user equipment corresponding to an additional subscriber indicia associated with an additional user account of the V2X application.

20. The system of claim 14, wherein the communication settings include opt-in settings to receive the traffic advisory message.
